(19) United States
(12) Patent Application Publication
(10) Pub. No.: US 2025/0271081 A1
(43) Pub. Date: Aug. 28, 2025

(54) RETAINING CLIP DEVICE

(71) Applicant: Daniel Wiley, Windham, ME (US)

(72) Inventor: Daniel Wiley, Windham, ME (US)

(21) Appl. No.: 18/587,423

(22) Filed: Feb. 26, 2024

(51) Int. Cl. F16L 3/06; E04H 15/64

(52) U.S. Cl. CPC F16L 3/06; E04H 15/64

(57) ABSTRACT

The present invention is a retaining clip device. The clip device is designed to be attached to a frame or structure. The clip device includes a hook or clip designed to be attached to a piece of equipment such as a net, tent material, or tarp. The clip device is designed to hold the piece of equipment in a position relative to the frame or structure. The clip device is adjustable on both the structure attachment and the equipment attachment such that the equipment may be situated, moved, or adjusted with respect to the frame or structure as necessary. One or more clip devices may be used to removably retain the equipment on the frame or structure in the position desired.

### BACKGROUND OF THE INVENTION

### 1. Field of the Invention

The present invention relates to a retaining clip device. More specifically, the present invention relates to an adjustable and movable retaining clip device. Still more specifically, the present invention relates to a retaining clip device which selectively and adjustably attaches equipment to a framing structure.

### 2. Description of the Prior Art

There currently exists hook and clip devices for various uses designed to retain one structure to another structure. These clip devices are typically an anchoring device used with tents to attach the tent material to the pole structure. The clips are typically used with one end anchored to either the tent material or the pole structure. The second end has a hook or loop which can be attached to another receiving structure like a loop or other type of clip.

In typical formations, these clips are sewn, looped, stitched, or otherwise attached to the tent material. When utilizing the clips, they may be attached to the pole structure after the pole structure has been set up. The design is to provide a method where the tent can be broken down and stored in a compact method. When in use, the clips provide tension to erect the tent material around the pole structure.

Current clips are designed to be spaced appropriately and affixed such that they provide complimentary tension throughout the tent material to properly align the tent material and the pole structure to independently keep the tent erected through tension. The clips must be affixed to the tent material and retained in certain areas and with certain angular tension throughout the assembly to achieve the desired effect.

The clips will be sewn, stitched, or clasped onto either the tent material or the tent poles. When the user erects the tent, the clips, which are adhered to either of the structures, are then attached to the other structure. The clips are designed to be attached to a certain area to hold the tent material in a certain place and shape. If the desired shape is not adhered to, the tent material will not be held up properly and will be unusable. The clips are not designed to be placed, adjusted, moved, to other locations. The clips are not adjustable or movable such that the user can create varying structures with the tent.

What is needed is a retaining device which has a first adjustment method of attachment to a structure and a second adjustment method of attachment to a piece of equipment. The device should be removably attachable with both the first and second methods of attachment. The device should be able to be moved, adjusted, or otherwise manipulated, as desired by the user, with both attachment methods. Thus, the equipment can be moved, adjusted, re-shaped, or tensed in various ways and directions as desired by the user. The user should be able to make the equipment tighter or looser depending on the need.

### SUMMARY OF THE INVENTION

The present invention is a retaining clip device. The clip is designed to retain equipment to a framing structure. The clip has a first attachment element and a second attachment element. The first attachment element is designed to be removably attached to the framing structure. The second attachment element is designed to be removably attached to the equipment. The clip allows a user to adjustably attach equipment to a framing structure to use in a designed purpose.

In an embodiment, the equipment used may be a netting material and the framing structure may be a rigid polymer structure, like PVC piping. In this embodiment, the first attachment element is designed to be removably engaged to the PVC piping. The clip may be slid, moved, or otherwise adjusted to be in an appropriate position. The second attachment element is designed to be removably and adjustably engaged with the netting material. This may be in a hook or loop type feature where the netting material can be hooked onto the clip, thereby securing the netting to the framing structure.

In other embodiments, the clip may have a first attachment element designed to be removably retained to a wooden framing structure, metal pipe, or other type of structure. Additionally, the clip may have a second attachment element designed to be removably retained to a tarp, rope, strap, or other type of equipment feature.

The first attachment element is configured in a shape to be engaged with the framing structure. The shape of the first attachment element may be in a square, rectangle, oval, circle, or semi-circle configuration. The shape of the first attachment element is designed to provide as much friction on the framing structure as possible. The friction between the inner surface of the first attachment element allows the clip device to be held in the desired location on the framing structure.

The second attachment element is designed to be removably and adjustably retained to a piece of equipment. The equipment may be netting, rope, string, tent material, or other equipment. The second attachment element of the clip holds the equipment to the framing structure. The second attachment element is designed to easily receive or release the equipment through the use of a hook, latch, or other similar retaining feature. The retaining feature may be specifically designed to receive certain types of equipment. For example, in an embodiment, the second attachment element may be a hook to receive a looped string or rope. In another example, the second attachment element may be a broad, curved attachment designed to retain and hold a loop of a netting material.

It is a goal of the present invention to be used in conjunction with a framing structure and one or more pieces of equipment. The clip serves as a method of holding or retaining the piece of equipment in place, stabilized by the framing structure. The clip has a method of attachment to attach to the framing structure and a method of attachment to attach to the equipment. It is a goal of the clip to provide a method wherein the user can adjust positioning of the clip on the framing structure and adjust positioning of the clip on the piece of equipment to hold the equipment in the desired location and orientation.

### BRIEF DESCRIPTION OF THE DRAWINGS

FIG. 1 is a top perspective view of a first embodiment of the retaining device of the present invention.

FIG. 2 is a top perspective view of a second embodiment of the device having a tightening feature on the first attachment element.

FIG. 3 is a top perspective view of the second embodiment of the retaining device of the present invention with a framing structure and netting equipment.

FIG. 4 is a first side perspective of the second embodiment of the retaining device having a tightening bolt engaged with the tightening feature on the first attachment element.

FIG. 5 is a second side perspective of the second embodiment of the retaining device having a tightening bolt engaged with the tightening feature on the first attachment element.

### DETAILED DESCRIPTION OF THE INVENTION

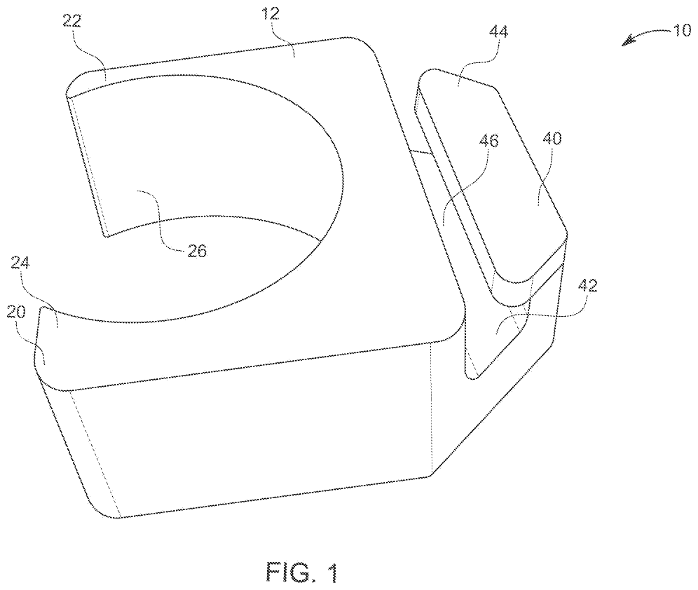

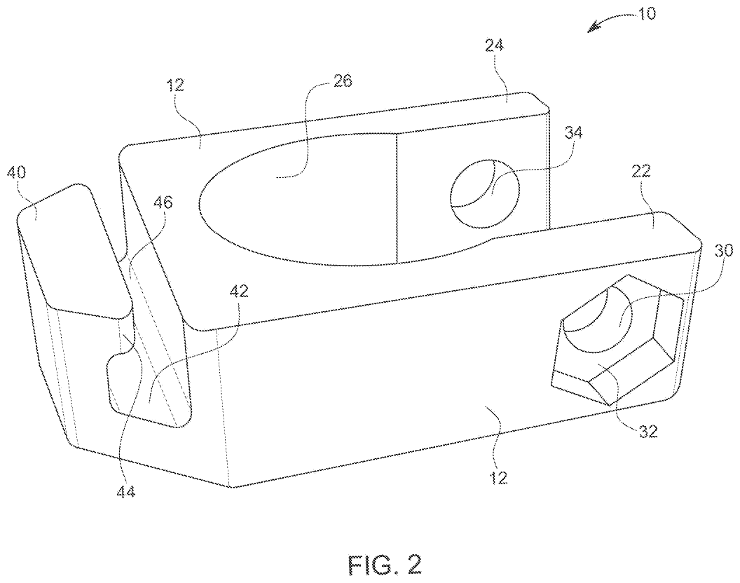

A first embodiment of the retaining device 10 of the present invention is shown in FIG. 1. The device has a body 12, a first attachment element 20, and a second attachment element 40. The first attachment element 20 has a first end 22, a second end 24, an inner surface 26, and an optional tightening component system 30 of a second embodiment shown in FIG. 2. The optional tightening component system 30 has a first side 32 and a second side 34. The second attachment element 40 has a retaining cavity 42, an edge 44, and an opening 46. The first attachment element 20 is designed to be engaged with a framing structure 60. The second attachment element 40 is designed to be engaged with equipment 80 to be releasably retained. The retained equipment 80 may have an attachment component 82.

The device 10 is designed to removably retain together the framing structure 60 and the retained equipment 80, such that the retained equipment 80 is held in the desired location with respect to the framing structure 60. In an embodiment, the framing structure 60 is a sturdy plastic structure, made out of polyvinyl chloride (PVC) pipe, for example, and the retained equipment 80 is a plastic net material. In such an embodiment, the device 10 is attached to the framing structure 60 by the first attachment element 20 and to the retained equipment 80 by the second attachment element 40. The first attachment element 20 is configured to allow the user to move, adjust, reattach, or otherwise relocate the device 10 anywhere on the framing structure 60. The second attachment element 40 is configured to allow the user to move, adjust, reattach, or otherwise relocate the retained equipment 80 with respect to the framing structure 60.

The first attachment element 20 is configured to align to or complement the framing structure 60. In an embodiment, the framing structure 60 is a circular PVC pipe. In this configuration, the first attachment element 20 is formed as a circle or semi-circle shape such that the second attachment element 40 may fit snugly around the PVC pipe 60. In another embodiment, the framing structure 60 may be a square or rectangle piece of wood. In this configuration, the first attachment element 20 is formed in a square or rectangle shape such that the first attachment element 20 may fit snugly around the wood 60. The material of the device 10 is selected so that the first attachment element 20 may establish at least a frictional fit about the framing structure 60. For example, at least a portion of the device 10 may be made of a nonmetallic material, such as a plastic material.

The second attachment element 40 is configured to receive a component of the retained equipment 80. As noted, the retained equipment 80 may be a net material, tent material, tarp, or other equipment which may be secured to the framing structure 60 by the device 10. The second attachment element 40 is configured such that the retained equipment 80 may be placed around the second attachment element 40 and thereby retained in place. The second attachment element 40 may be formed as a hook, an extended hook, a loop, or other such configuration that may receive the retained equipment 80. In an embodiment, the retained equipment 80 is a netting material. The device 10 is attached to the framing structure 60. A loop or loops may form the attachment component 82 of the netting material 80 and may be placed around the second attachment element 40 wherein the netting material 80 is secured to the framing structure 60 by the device 10. The second attachment element 40 may be made of the same material or a different material as used to make the first attachment element 20 portion of the device.

FIG. 1 depicts the first embodiment of the device 10 wherein the device 10 is configured to be engaged with the PVC pipe 60 and netting material as the retained equipment 80. The first end 22 and the second end 24 of the first attachment element 20 are formed in a semi-circle shape to allow the user to clip the device 10 to the PVC pipe 60. The first end 22 and the second end 24 form pressure to create a friction fit between the inner surface 26 and the PVC pipe 60 to retain the device 10 in place on the pipe 60. The second attachment element 40 is configured to receive a loop or loops 82 of the netting material as the retained equipment 80. The loop or loops 82 of the netting material 80 may be placed over the edge 44 into the retaining cavity 42 through the opening 46 of the second attachment element 40. The loop or loops 82 are retained within the retaining cavity 42 to hold the netting material 80 in place. The device 10 is designed to be used with one or more of the device 10 to hold the retained equipment 80 in multiple locations along the framing structure 60.

As depicted in FIGS. 2-5, the second embodiment of the device 10 may be configured to have an optional tightening component 30. The tightening component 30 may be configured to have a first side 32 and a second side 34 capable of receiving a tightener 36. The tightener 36 may be a bolt, screw, rubber band, or other method of tightening the gap between the first side 32 and the second side 34. The tightener 36 may also have an optional nut 38 to facilitate the tightening. In this configuration, the tightening component 30 is designed to allow the user to apply additional pressure between the first end 22 and second end 24 of the first attachment element 20. The additional pressure squeezes the first end 22 and the second end 24 of the first attachment element 20 creates additional friction between the inner surface 26 and the framing structure 60, thereby holding the device 10 firmly in place on the framing structure 60.

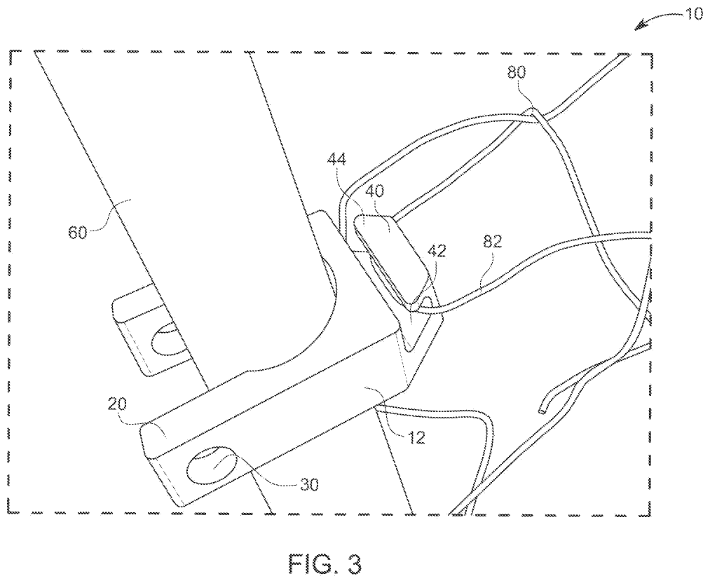

FIG. 3 depicts the device 10 in use with a PVC pipe as the framing structure 60 and the netting material as the retained equipment 80. The inner surface 26 of the first attachment element 20 is in contact with the PVC pipe 60, creating friction and thereby holding the device 10 in place on the pipe 60. The retaining cavity 42 of the second attachment element 40 retains a loop 82 of the netting material 80. The opening 46 is designed to allow the user to place or remove a loop 82 of the netting material 80 into the retaining cavity 42. The edge 44 of the second attachment element 40 is effectively a shoulder designed to restrict the ability of the loop 82 of the netting material 80 to easily slip unintentionally off the second attachment element 40 while still making it easy to intentionally move the netting material 80 on and off the second attachment element 40.

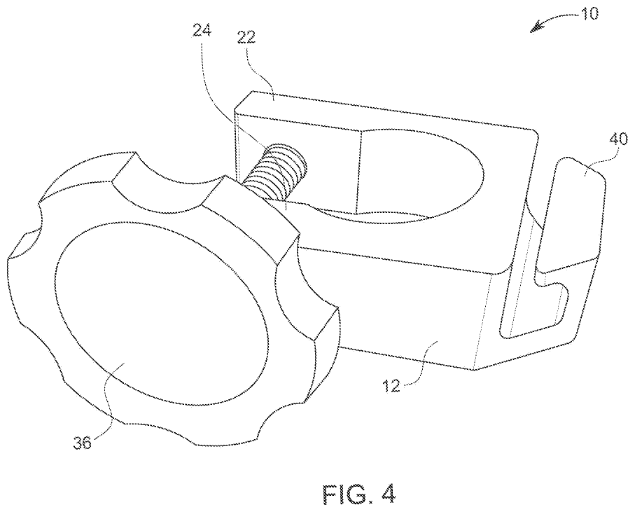

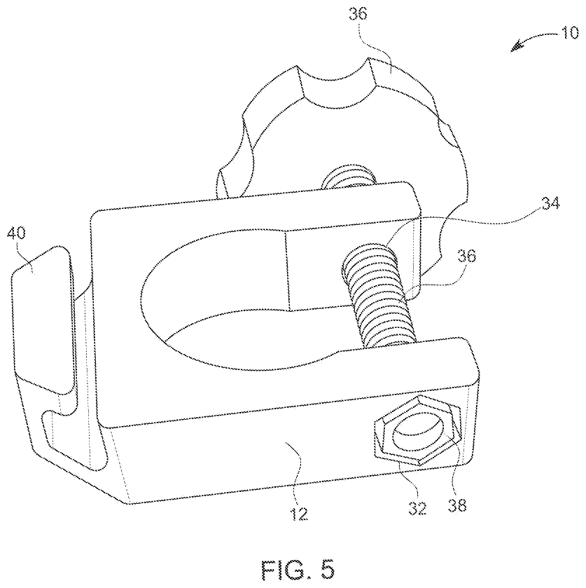

FIGS. 4-5 depict the device 10 with the tightener 36 engaged with the optional tightening component 30. The tightener 36 is configured to attach to the first side 32 and the second side 34. The optional nut 36 may be engaged with either the first side 32 or the second side 34. As depicted in FIG. 4-5, the tightener 36 is a hand bolt. The nut 38 is engaged with the first side 32. The device 10 is placed around the framing structure 60. The tightener 36, facilitated by the nut 38, is then twisted to bring the first side 32 and the second side 34 closer together, thus securing the device 10 onto the framing structure 60.

The second attachment element 40 of the device 10 is equipped to receive and retain various attachment components 82 of the retained equipment 80. For example, the attachment component 82 may be made of a string, rope, loop, or other type of component that can be hooked into and retained within the retaining cavity 42 of the second attachment element 40. The attachment component 82 may be an existing feature of the retained equipment 80, such as a loop of a netting material. Alternatively, the attachment component 82 may be a secondary feature added to the retained equipment 80 like a stitched or sewed loop, an attached rope, strap, or other attachment method. The second attachment element 40 may also be configured as a clasp, latch, or other type of attaching method. For example, the edge 44, rather than being a restraining shoulder as shown, may be configured to be a latch or clasp that touches or hooks onto the body 12 of the device. In this embodiment, the edge 44 may be latched, attached, or otherwise held to the body 12 to ensure the attachment component 82 remains in the retaining cavity 42.

The device 10 is configured for both the first attachment element 20 and the second attachment element 40 to be adjustable, movable, and able to be detached and reattached, as needed. The first attachment element 20 can be adjusted, unclipped, removed, or otherwise moved from the framing structure 60 and replaced in a location as desired. Additionally, the first attachment element 20 is configured such that the device 10 may be slid or pushed along the framing structure 60 without requiring the device 10 to be fully removed to be relocated on the framing structure 60. The retained equipment 80 may also be adjusted, unclipped, removed, or otherwise moved within the retaining cavity 42 of the second attachment element 40. The retained equipment 80 may be adjusted, as necessary, while still retained in the second attachment element 40, or may be removed from and reattached to the second attachment element 40 as needed.

The device 10 is configured to be of a size to allow for the use of multiple devices 10 to be used in conjunction with each other. The framing structure 60 may be of various sizes, allowing for a plurality of the devices 10 to be used to properly align the retained equipment 80 in a shape, orientation, and alignment on the framing structure 60 as desired by the user. The device 10 may be equipped with low-profile features or have a sufficiently thin body 12 to be used in corners of the framing structure 60.

The present invention has been described with reference to specific examples and configurations. The description is not to be taken in a limiting sense but is made merely for the purpose of illustrating the general principles of the invention, since the scope of the invention is best defined by the appended claims.

What is claimed is:

1. A retaining clip device for removably retaining one or more components to a framing structure, the device comprising:
a body;
a first attachment element; and
a second attachment element;
wherein the first attachment element is equipped to be selectively, removably, and adjustably retained to the framing structure; and
wherein the second attachment element is equipped to selectively and adjustably retain thereto the one or more.

2. The device of claim 1 wherein the first attachment element is configured in a circle or semi-circle to be retained on a circular framing structure.

3. The device of claim 1 wherein the first attachment element is configured in a rectangle to be retained on a rectangle framing structure.

4. The device of claim 1 wherein the first attachment element is retained to the framing structure having a shape designed to create a frictional fit on said framing structure.

5. The device of claim 1 wherein the framing structure is made of wood, plastic, metal, or composite.

6. The device of claim 1 wherein the second attachment element is configured as a hook.

7. The device of claim 1 wherein the second attachment element is configured to receive and retain a rope, wire, or other net-like material.

8. The device of claim 1 wherein the one or more components comprise a net, rope, string, or wire.

9. The device of claim 1 wherein the first attachment element includes a tightening component.
